(19) United States
(12) Patent Application Publication
(10) Pub. No.: US 2016/0160875 A1
(43) Pub. Date: Jun. 9, 2016

(54) GAS TURBINE ENGINE WITH FAN CLEARANCE CONTROL

(71) Applicant: UNITED TECHNOLOGIES CORPORATION, Hartford, CT (US)

(72) Inventor: Frederick M. Schwarz, Glastonbury, CT (US)

(21) Appl. No.: 14/906,019

(22) PCT Filed: Jul. 16, 2014
(86) PCT No.: PCT/US14/46784

§ 371 Date: Jan. 19, 2016

Related U.S. Application Data
(60) Provisional application No. 61/869,799, filed on Aug. 26, 2013.

(51) Int. Cl. F04D 29/36; F01D 5/02; F04D 29/52; F01D 25/18; F04D 29/32; F01D 25/24; F01D 25/16

(52) U.S. Cl. CPC F04D 29/362; F01D 25/24; F01D 5/02; F01D 25/16; F01D 25/18; F04D 29/325; F04D 29/324; F04D 29/526; F05D 2220/32; F05D 2240/50; F05D 2240/60; F05D 2240/307; F05D 2260/40311

(57) ABSTRACT

A fan section for use in a gas turbine engine has a fan rotor with a plurality of blades and an outer fan housing surrounding the plurality of blades. A tip clearance is defined between a radially outer tip of the blades and a radially inner surface of the fan housing. A fan drive shaft drives the rotor. A drive input drives the fan drive shaft. A shifting mechanism shifts a location of the blades relative to the drive input, thereby controlling the tip clearance. A gas turbine engine is also disclosed.

### CROSS-REFERENCE TO RELATED APPLICATION

This application claims priority to U.S. Provisional Application No. 61/869,799, filed Aug. 26, 2013.

### BACKGROUND

This application relates to a fan rotor shifting system that provides clearance control for a gas turbine engine fan.

Gas turbine engines are known and, typically, include a fan delivering air into a compressor section. The air is compressed and then delivered into a combustor section where it is mixed with fuel and ignited. Products of this combustion pass downstream over turbine rotors driving them to rotate.

Historically, a single rotor may have driven a compressor section and a fan rotor at a single speed. This restricted the design of the fan, the compressor and the turbine.

More recently, it has been proposed to include a gear reduction between a fan drive turbine and the associated fan rotor. This allows the fan and the turbine to rotate at distinct speeds. With this change, a diameter of the fan rotor has increased. To accommodate the weight gain from the increased size fan, fan blades are becoming made of lighter materials, such as aluminium.

When made of aluminium, the fan blades are especially sensitive to heat and can expand during operation of the gas turbine engine. As the fan rotor and blades change size, a clearance between the fan blades and an outer housing can change and the efficiency of the gas turbine engine can decrease.

Similar problems can occur in the compressor and it has been proposed to shift compressor rotors to take up detected clearance or anticipated clearance. However, it has not been proposed to shift a fan rotor.

It has also been proposed to shift a housing outwardly of the compressor rotors to control clearance. While it has been proposed to shift the housing associated with the fan, no system for facing the challenges that would occur during such movement has been disclosed.

Fan blades have been rotated to change a pitch angle, however, they have not been moved to take up undesired clearance.

### SUMMARY

In a featured embodiment, a fan section for use in a gas turbine engine has a fan rotor with a plurality of blades and an outer fan housing surrounding the plurality of blades, with a tip clearance defined between a radially outer tip of the blades and a radially inner surface of the fan housing. A fan drive shaft drives the rotor. A drive input drives the fan drive shaft. A shifting mechanism shifts a location of the blades relative to the drive input, thereby controlling the tip clearance.

In another embodiment according to the previous embodiment, the drive input is an output shaft of a gear reduction the drives the fan rotor.

In another embodiment according to any of the previous embodiments, a shifting mechanism shifts a first element to, in turn, move an outer race of a bearing axially. The outer race of the bearing, in turn, moves an inner race as it moves axially. The inner race is fixed for movement with the fan drive shaft. Axial movement of the inner race results in axial movement of the fan drive shaft to shift the location of the blades.

In another embodiment according to any of the previous embodiments, a lubricant supply system supplies lubricant to the bearing.

In another embodiment according to any of the previous embodiments, the lubricant supply system includes a plurality of lubrication tubes positioned radially inwardly of the drive input. The drive input has communication holes for supplying lubricant radially outwardly into mating lubricant holes within the fan drive shaft. Oil is supplied through the holes in the fan drive shaft to the bearing.

In another embodiment according to any of the previous embodiments, the first element is constrained to move axially and move with the outer race axially. The second element drives the first element to move axially, and is to rotate. There are mating teeth between the first and second elements.

In another embodiment according to any of the previous embodiments, there are a pair of bearing members between the inner and outer races. An axially inner bearing member has an axially outer end. The teeth on the second element extend axially inward of the axially outer end. An axially inner end of an axially outer bearing member is defined. The teeth on the second element extend axially outwardly of the axially inner end.

In another embodiment according to any of the previous embodiments, the mating teeth extend for the majority of an axial length occupied by the bearing.

In another embodiment according to any of the previous embodiments, the second element is driven to rotate by a rack and pinion device.

In another embodiment according to any of the previous embodiments, a control for the shifting mechanism receives clearance information from a sensor and also receives flight information, and determines a desired position for the blades based upon both the sensor information and the flight information.

In another featured embodiment, a gas turbine engine has a fan section, a compressor section, and a turbine section. The fan section includes a fan rotor having a plurality of blades and an outer fan housing surrounding the plurality of blades. A tip clearance is defined between a radially outer tip of the blades and a radially inner surface of the fan housing. A fan drive shaft drives the rotor. A drive input drives the fan drive shaft. A shifting mechanism shifts a location of the blades relative to the drive input thereby controlling the tip clearance.

In another embodiment according to the previous embodiment, the drive input is an output shaft of a gear reduction for driving the fan rotor.

In another embodiment according to any of the previous embodiments, a shifting mechanism shifts a first element to, in turn, move an outer race of a bearing axially. The outer race of the bearing, in turn, moves an inner race as it moves axially. The inner race is fixed for movement with the fan drive shaft. The axial movement of the inner race results in axial movement of the fan drive shaft to shift the location of the blades.

In another embodiment according to any of the previous embodiments, a lubricant supply system supplies lubricant to the bearing.

In another embodiment according to any of the previous embodiments, the lubricant supply system includes a plurality of lubrication tubes positioned radially inwardly of the drive input. The drive input has communication holes for supplying lubricant radially outwardly into mating lubricant holes within the fan drive shaft. Oil is supplied through the holes in the fan drive shaft to the bearing.

In another embodiment according to any of the previous embodiments, the first element is constrained to move axially and move with the outer race axially. A second element drives the first element to move axially, and is constrained to rotate. There are mating teeth between the first and second elements.

In another embodiment according to any of the previous embodiments, there are a pair of bearing members between the inner and outer races. An axially inner bearing member has an axially outer end. The teeth on the second element extend axially inward of the axially outer end. An axially inner end of an axially outer bearing member is defined. The teeth on the second element extend axially outwardly of the axially inner end.

In another embodiment according to any of the previous embodiments, the mating teeth extend for the majority of an axial length occupied by the bearing.

In another embodiment according to any of the previous embodiments, the second element is driven to rotate by a rack and pinion device.

In another embodiment according to any of the previous embodiments, a control for the shifting mechanism receives clearance information from a sensor and also receives flight information, and determines a desired position for the blades based upon both the sensor information and the flight information.

These and other features may be best understood from the following drawings and specification.

### BRIEF DESCRIPTION OF THE DRAWINGS

FIG. 1 schematically shows a gas turbine engine.

FIG. 2 shows a novel gas turbine engine.

FIG. 3 shows a detail of the FIG. 2 engine.

### DETAILED DESCRIPTION

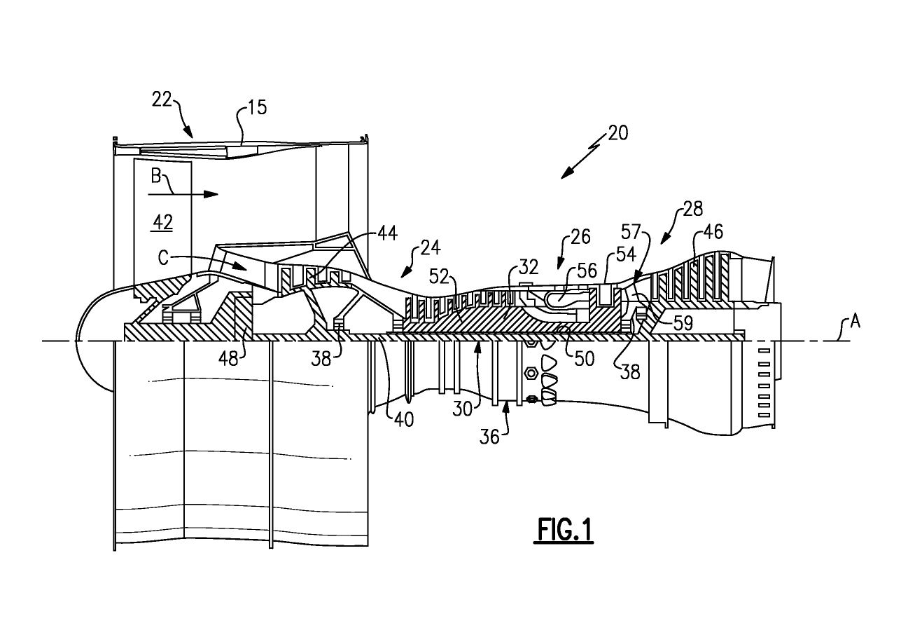

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second.

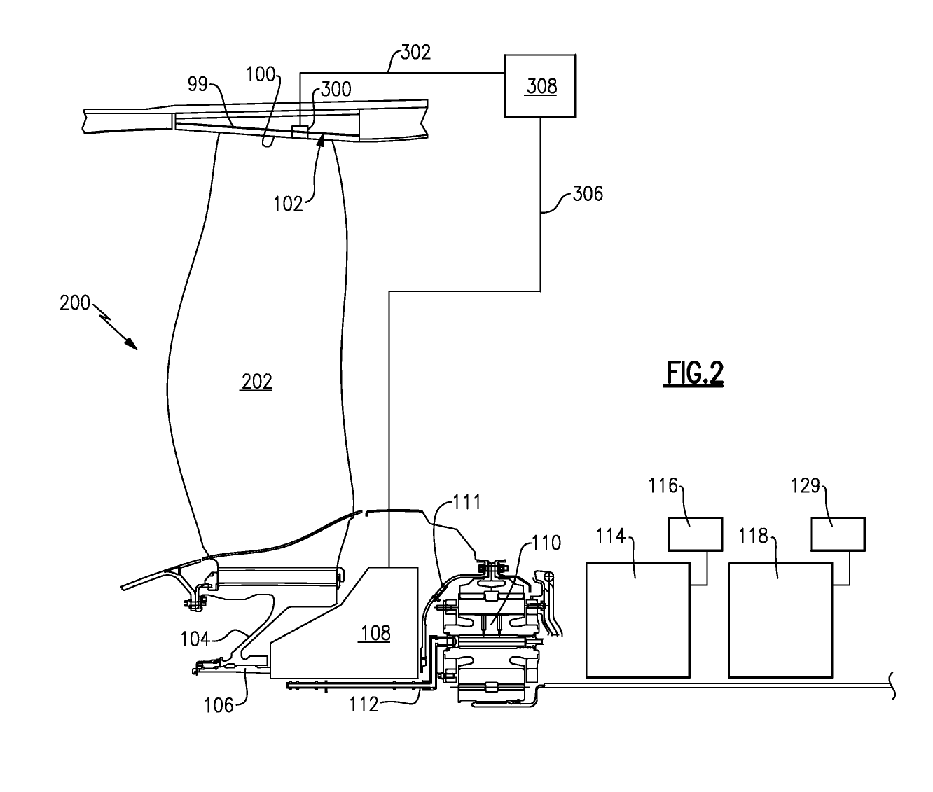

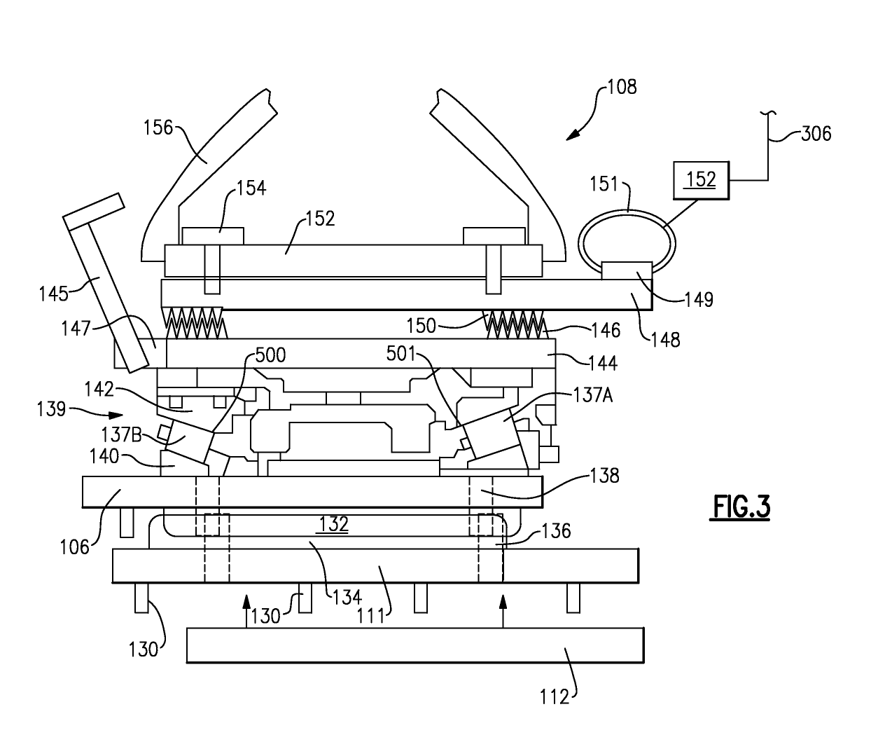

A fan blade shifting system 200 which may be incorporated into an engine, such as engine 20 of FIG. 1, is illustrated in FIG. 2. Fan blades 202 are driven through a gear reduction 110, as described above. An oil supply, such as supply tubes 112, delivers oil from the gear reduction 110 to a fan shift mechanism 108. The fan shift mechanism is described below with regard to FIG. 3. However, as shown schematically in FIG. 2, a drive input 111 from the gear reduction 110 provides a drive input into the fan shift mechanism and a fan drive shaft 106, in turn, drives a fan rotor 104 to rotate the fan blades 202.

A sensor 300 senses a clearance between a radially outer tip 102 of the fan blades 202 and a radially inner surface 100 of an outer housing 99. The sensor senses this clearance and provides a signal through line 302 to a controller 308, which may be a standalone controller or may be a full authority digital aircraft controller, as known.

The control 308 controls the shift mechanism 108 through a line 306. The control 308 may be provided with feedback from the operation of the engine, such as an indication of the thrust being demanded on the engine. The control 308 may thus anticipate changes in the clearance between surfaces 102 and 100 based upon engine operation and/or may be responsive to the sensor readings from sensor 300.

In addition, the control 308 may “learn” to anticipate clearance as engine operations changes by remembering clearance information that occurs during past engine operation. This will assist the control 308 in continuing to operate the system 108, even given the failure of a sensor 300.

As shown in FIG. 2, similar shifting mechanisms 116 and 120 can be provided for shifting a low pressure compressor 114 and a high pressure compressor 118 relative to their housings. This structure may be as known in the art. However, the shifting of the fan rotor and both a low and high compressor rotor is not known in the prior art.

Shifting the fan rotor raises challenges that are not seen by shifting compressors rotors. This becomes particularly the case when a gear reduction, such as gear reduction 110, is utilized to drive a fan rotor. As an example, a gear reduction requires a “true” output shaft which is on an expected axis. By including the ability to shift the fan drive shaft 106, it becomes a challenge to ensure the output shaft is “true.” In addition, with the use of the gear reduction, the outer diameter of the fan blades typically becomes greater. Thus, a “blade-out load” will also increase, and any shifting assembly must be able to accommodate such larger loads.

As is known, a drive connection between a fan drive turbine (such as turbine 46 shown in FIG. 1) and the gear reduction 110 may be flexible.

The shifting mechanism 108 is illustrated in FIG. 3. As shown, the supply tube 112 supplies oil radially outwardly against the drive input 111. The drive input 111 is driven by the gear reduction as shown schematically in FIG. 2. Oil tubes 112 may be spaced circumferentially about an axis of rotation and generally are stationary. “Catching” features 130 are provided on an underside of the drive input 111 and deliver oil through a first set of oil holes 136 and into the fan drive shaft 106. A second set of holes 138 communicates with the first set of holes 136. From the second set of holes 138, the oil flows to a bearing 139.

As shown in FIG. 3, spline teeth 134 are provided on the drive input 111 and mating spline teeth 132 are provided on the fan drive shaft 106. The oil supply holes 136/138 can be provided circumferentially intermediate the splines or could extend through selected portions of the splines.

During operation, lubricant will be provided from the spray tubes 112 through the holes 136/138 and to the inner race 140 of bearing 139. As known, the inner race 140 rotates with the fan drive shaft 106.

An outer race 142 of the bearing 139 does not rotate, as known. As shown in FIG. 3, bearing members 137A and B are tapered and allow relative rotation of the inner race 140 relative to the outer race 142. As known, the bearing members 137A and B are located between races 140 and 142.

A shifting element 144 is fixed to move axially with the outer race 142. A plurality of slots 147 are provided in the shifting element 144 and receive connections 145 within the slots 147. The portions 145 are fixed to a frame of the engine. Thus, the element 144 is constrained to move axially, but is not allowed to rotate due to the frame connections 145.

As shown, a first set of teeth 146 mate with a second set of teeth 150 on a drive element 148. Drive element 148 is pinned at 154 to a non-rotating member 152 which is connected as shown schematically at 156 to the frame of the engine. Thus, the element 148 is allowed to rotate and drives the element 144 to move axially. When the element 144 moves axially, it moves the outer race 142 axially and this shifts the inner race 140, which moves the fan drive shaft 138 along the spline connection 132 and 134 and relative to the gear drive input 111.

In this manner, an axial location of the fan blades 202 changes. As can be appreciated from FIG. 2, the surfaces 100 and 102 are generally conical. Thus, as the relative axial location of the blades 202 changes relative to the housing 99, the amount of clearance between surfaces 100 and 102 changes. Again, the control 308 could be programmed to anticipate or monitor a clearance and move the fan blades to achieve an ideal clearance during engine operation.

The element 148 has pinion teeth 149 and a rack drive 151 rotates the pinion teeth. A motor 152 is shown and communicates with the control through the line 306, as mentioned above.

As shown in FIG. 3, a “wheel base” of the teeth 146 and 150 is relatively wide and covers the majority of an axial distance occupied by the bearing 139. More generally, the teeth 150 cover at least fifty (50) percent of the axial length of the bearing 139.

An axially inner one of the bearing members 137A has an axially outer end 501, and the teeth 150 extend axially inward of the outer end 501. Further, an axially inner end 500 of an axially outer bearing member 137B is defined, and the teeth 150 extend axially outwardly of the axially inner end 500.

The relatively wide wheel base for the teeth assists the fan shifting device 108 in reducing blade-out loads and wobbling loads which may otherwise occur with the relatively large fan as it experiences operational challenges and forces.

As a worker of ordinary skill in the art would recognize, the total distance that the blades would need to shift to provide the disclosed function is very small. For example, the total shifting may be less than 1.0 inch (2.54 cm), even in a very large gas turbine engine.

Although an embodiment of this invention has been disclosed, a worker of ordinary skill in this art would recognize that certain modifications would come within the scope of this disclosure. For that reason, the following claims should be studied to determine the true scope and content of this disclosure.

1. A fan section for use in a gas turbine engine comprising:
a fan rotor having a plurality of blades and an outer fan housing surrounding said plurality of blades, with a tip clearance defined between a radially outer tip of said blades and a radially inner surface of said fan housing;
a fan drive shaft for driving said rotor;
a drive input for driving said fan drive shaft; and
a shifting mechanism for shifting a location of said blades relative to said drive input, thereby controlling the tip clearance.

2. The fan section as set forth in claim 1, wherein said drive input is an output shaft of a gear reduction for driving said fan rotor.

3. The fan section as set forth in claim 2, wherein a shifting mechanism shifts a first element to, in turn, move an outer race of a bearing axially, said outer race of said bearing, in turn, moving an inner race as it moves axially, said inner race being fixed for movement with said fan drive shaft, and axial movement of said inner race resulting in axial movement of said fan drive shaft to shift the location of the blades.

4. The fan section as set forth in claim 3, wherein a lubricant supply system supplies lubricant to said bearing.

5. The fan section as set forth in claim 4, wherein said lubricant supply system includes a plurality of lubrication tubes positioned radially inwardly of said drive input and said drive input having communication holes for supplying lubricant radially outwardly into mating lubricant holes within said fan drive shaft and oil being supplied through said holes in said fan drive shaft to said bearing.

6. The fan section as set forth in claim 3, wherein said first element is constrained to move axially and move with said outer race axially, and a second element driving said first element to move axially, said second element being constrained to rotate, and there being mating teeth between said first and second elements.

7. The fan section as set forth in claim 6, wherein there are a pair of bearing members between said inner and outer races, an axially inner bearing member has an axially outer end, and the teeth on said second element extend axially inward of said axially outer end, an axially inner end of an axially outer bearing member is defined, and said teeth on said second element extend axially outwardly of said axially inner end.

8. The fan section as set forth in claim 6, wherein said mating teeth extend for the majority of an axial length occupied by said bearing.

9. The fan section as set forth in claim 6, wherein said second element is driven to rotate by a rack and pinion device.

10. The fan section as set forth in claim 1, wherein a control for said shifting mechanism receives clearance information from a sensor and also receives flight information, and determines a desired position for said blades based upon both said sensor information and said flight information.

11. A gas turbine engine comprising:
a fan section, a compressor section, and a turbine section;
said fan section including a fan rotor having a plurality of blades and an outer fan housing surrounding said plurality of blades, with a tip clearance defined between a radially outer tip of said blades and a radially inner surface of said fan housing, a fan drive shaft for driving said rotor, a drive input for driving said fan drive shaft; and
a shifting mechanism for shifting a location of said blades relative to said drive input thereby controlling the tip clearance.

12. The gas turbine engine as set forth in claim 11, wherein said drive input is an output shaft of a gear reduction for driving said fan rotor.

13. The gas turbine engine as set forth in claim 12, wherein a shifting mechanism shifts a first element to, in turn, move an outer race of a bearing axially, said outer race of said bearing, in turn, moving an inner race as it moves axially, said inner race being fixed for movement with said fan drive shaft, and axial movement of said inner race resulting in axial movement of said fan drive shaft to shift the location of the blades.

14. The gas turbine engine as set forth in claim 13, wherein a lubricant supply system supplies lubricant to said bearing.

15. The gas turbine engine as set forth in claim 14, wherein said lubricant supply system includes a plurality of lubrication tubes positioned radially inwardly of said drive input and said drive input having communication holes for supplying lubricant radially outwardly into mating lubricant holes within said fan drive shaft and oil being supplied through said holes in said fan drive shaft to said bearing.

16. The gas turbine engine as set forth in claim 13, wherein said first element is constrained to move axially and move with said outer race axially, and a second element driving said first element to move axially, said second element being constrained to rotate, and there being mating teeth between said first and second elements.

17. The gas turbine engine as set forth in claim 16, wherein there are a pair of bearing members between said inner and outer races, an axially inner bearing member has an axially outer end, and the teeth on said second element extend axially inward of said axially outer end, an axially inner end of an axially outer bearing member is defined, and said teeth on said second element extend axially outwardly of said axially inner end.

18. The gas turbine engine as set forth in claim 16, wherein said mating teeth extend for the majority of an axial length occupied by said bearing.

19. The gas turbine engine as set forth in claim 16, wherein said second element is driven to rotate by a rack and pinion device.

20. The gas turbine engine as set forth in claim 11, wherein a control for said shifting mechanism receives clearance information from a sensor and also receives flight information, and determines a desired position for said blades based upon both said sensor information and said flight information.

21. A gas turbine engine comprising:
a fan section, a compressor section including at least a first and second compressor rotor, and a turbine section, said fan section having a rotor and fan blades, and there being an outer fan housing, and there being an adjustment mechanism for moving said fan rotor relative to said outer fan housing to control a clearance between an outer periphery of said fan blades and an inner periphery of said outer fan housing; and
each of said first and second compressor rotors being surrounded by a compressor housing, and there being an adjustment mechanism for adjusting a position of each of said first and second compressor rotors relative to a respective one of said compressor housings to control a clearance between a radially outer surface on compressor blades in each of said first and second compressor rotors and a radially inner surface of said compressor housings.
